(19) United States
(12) Patent Application Publication
(10) Pub. No.: US 2013/0270367 A1
(43) Pub. Date: Oct. 17, 2013

(54) ASSEMBLY FOR PRODUCING FORFICIFORM SPRAY

(71) Applicants: Huasong Zhou, Xiamen (CN); Yangfeng Ji, Xiamen (CN); Jianmin Chen, Xiamen (CN); Zunyu Cai, Xiamen (CN)

(72) Inventors: Huasong Zhou, Xiamen (CN); Yangfeng Ji, Xiamen (CN); Jianmin Chen, Xiamen (CN); Zunyu Cai, Xiamen (CN)

(73) Assignees: XIAMEN SOLEX HIGH-TECH INDUSTRIES CO., LTD., Xiamen, Fujian (CN); Huasong ZHOU, Xiamen, Fujian (CN)

(21) Appl. No.: 13/976,899

(22) PCT Filed: Dec. 23, 2011
(86) PCT No.: PCT/CN2011/084546

§ 371 Date: Jun. 27, 2013

(30) Foreign Application Priority Data
Dec. 29, 2010 (CN) 201020688029.0

(51) Int. Cl. B05B 1/34

(52) U.S. Cl. CPC B05B 1/341
USPC 239/428.5

(57) ABSTRACT

The present invention is provided with an assembly for producing forficiform spray, which comprising a base body, the base body is disposed with a waterway inside; the waterway includes an inlet, an outlet and a circular cavity, the circular cavity is connected between the inlet and the outlet; the diameter of the outlet is larger than that of the inlet, the outlet is conical shaped with big end down; the joint of the inlet and the circular cavity is chamfered arc. When water flows into the cavity from the inlet, with the characteristics of the water, the outlet water forms a forficiform water of periodicity open and close; the present invention is full in granule, better suction effect, visual effect and massage effect.

### FIELD OF THE INVENTION

The present invention relates to an assembly for producing forficiform spray.

### BACKGROUND OF THE INVENTION

In the exiting technology, especially in switch assembly in a shower or a nozzle, there is fewer assembly to produce forficiform spray of periodicity open and close; the existing technology has problems that the period of the forficiform spray is unstable, the water splash is dull, the water is weak in granule and weak in suction effect and intermittently leaking may happen during suction.

### SUMMARY OF THE INVENTION

The object of the present invention is to solve the problems of the existing technology that the period of the forficiform spray is unstable, the water splash is dull, the water is weak in granule and weak in suction effect and intermittently leaking may happen during suction.

To solve above problems, the present invention is applied with a technical proposal as below:

An assembly for producing forficiform spray, comprising a base body, the base body is disposed with a waterway inside; the waterway includes an inlet, an outlet and a circular cavity, the circular cavity is connected between the inlet and the outlet; the diameter of the outlet is larger than that of the inlet, the outlet is conical shaped with big end down; the base body is disposed with an air hole throughout of the circular cavity inside and outside.

The joint of the inlet and the circular cavity is chamfered arc.

The base body includes a cavity body, which includes a main water body and a cover, the main water body is disposed with the inlet, the outlet and a circular groove connected between the inlet and the outlet, the main water body is fixed to the cover; the circular groove is formed the circular cavity.

The base body further includes an inlet nozzle, the centre of which is a hollow inlet waterway, one end of the inlet nozzle is disposed with external threaded, the other end is a flanged base, the flanged base is disposed with thread holes, the upper end of the cavity is disposed with thread holes corresponding to the thread holes of the flanged base of the inlet nozzle in position and size.

The bottom of the circular groove is in a same horizontal plane, the inlet and the outlet are separately disposed with the upper and the lower end of the circular groove in the radial direction; the outlet is forked tail shaped of big end down.

The air hole is disposed at the bottom of the circular groove in the position near the inlet.

The bottom of the circular groove of the main water body is disposed with two air holes.

Two air holes are symmetrically disposed in two sides of the line of the centers of the inlet and the outlet.

The end of the main water body and the cover near the inlet is disposed with an airway corresponding to the air hole in quantity and position, the airway is connected to the air hole.

A through hole is disposed in the flanged base of the inlet nozzle in the position corresponding to the airway.

The water from the inlet is stagnated in the joint of the inlet and the circular groove, and then the water is dispersed when it is running into the circular groove, one part of the water runs out of the outlet, the other part impacts two circular-like inner walls of the circular groove to form a feedback water; the feedback water and the main water from the inlet form a closed water cavity; the closed water cavity is gradually contracted to make the two air holes at the bottom of the circular groove worked with strong suction, making the air entering into the circular groove from the airway and the air hole; the air is mixed with the main water, making the specific volume of the mixture doubled and increased; when the mixture is running out of the outlet in high speed, one part is adhesion to the two sides of the forktail-like outlet, increasing the spraying area;

The other time the volume of the inlet is less than that of the outlet, water in two sides of the outlet is dropping down, one part of the water is directly running out of the outlet, reducing the spraying area; the other part of the water impacts the walls of the circular groove again to form feedback water, the feedback water and the main water from the inlet form closed water cavity again, the closed water cavity is contracted again, making the air hole worked with suction again, again the water is sprayed with large area from the forktail-like outlet, the water is forficiform water.

The present invention is provided with an assembly for producing forficiform spray, the period of forficiform spray is stable, the water is full in granule, the suction effect is obvious, and it has well visual effect. When the present invention is assembled in a massage nozzle, the forficiform spray is good for the body with well massage effect. And the assembly is simple in structure and low in cost. It is assembled by bolt, making it easy to clean.

### BRIEF DESCRIPTION OF THE DRAWINGS

The present invention will be further described with drawings and embodiments.

FIG. 1 illustrates the structure of a preferred embodiment of the present invention.

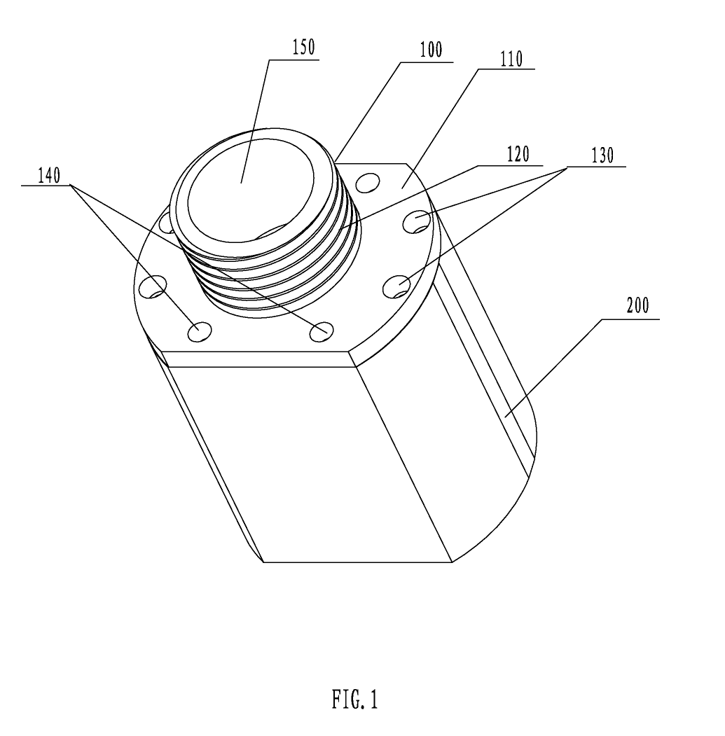

FIG. 2 illustrates the breakdown structure of a preferred embodiment of the present invention.

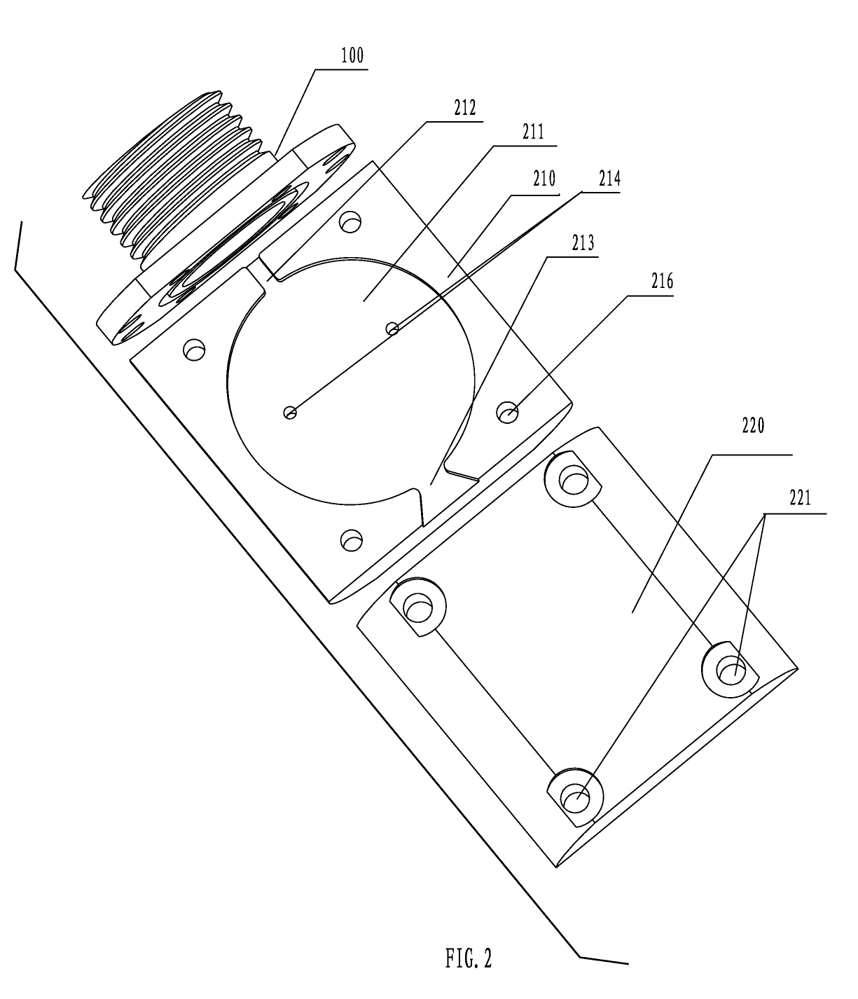

FIG. 3 illustrates the structure of the main water body of a preferred embodiment of the present invention.

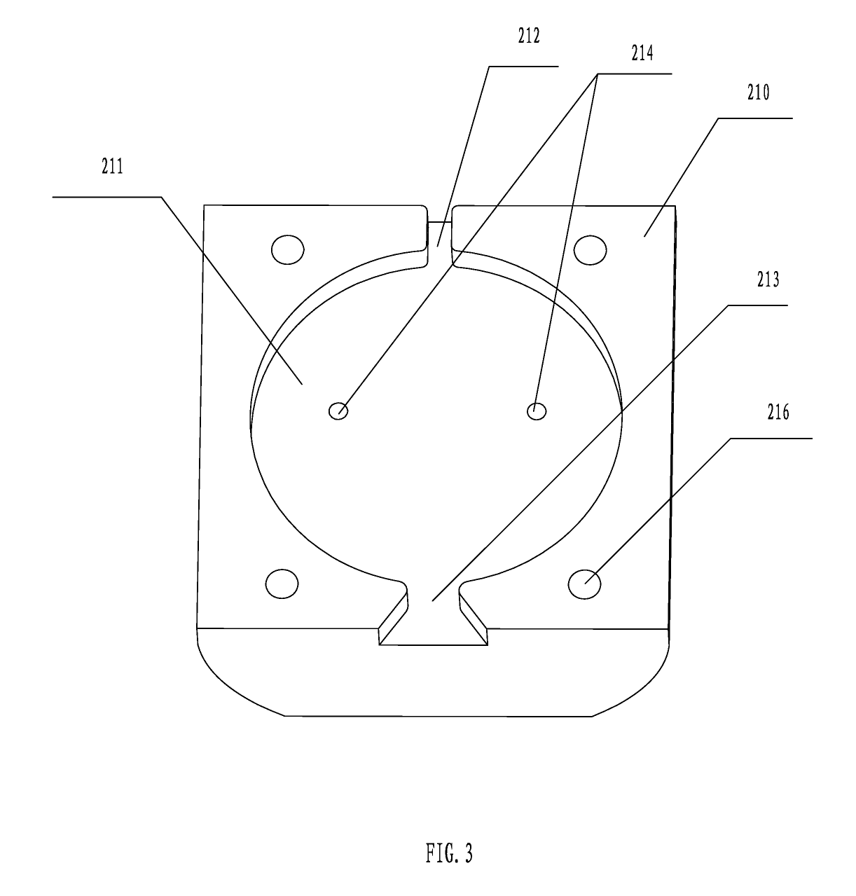

FIG. 4 illustrates the water flowing trend of the present invention.

FIG. 5 illustrates the sectional view of the front view of the present invention.

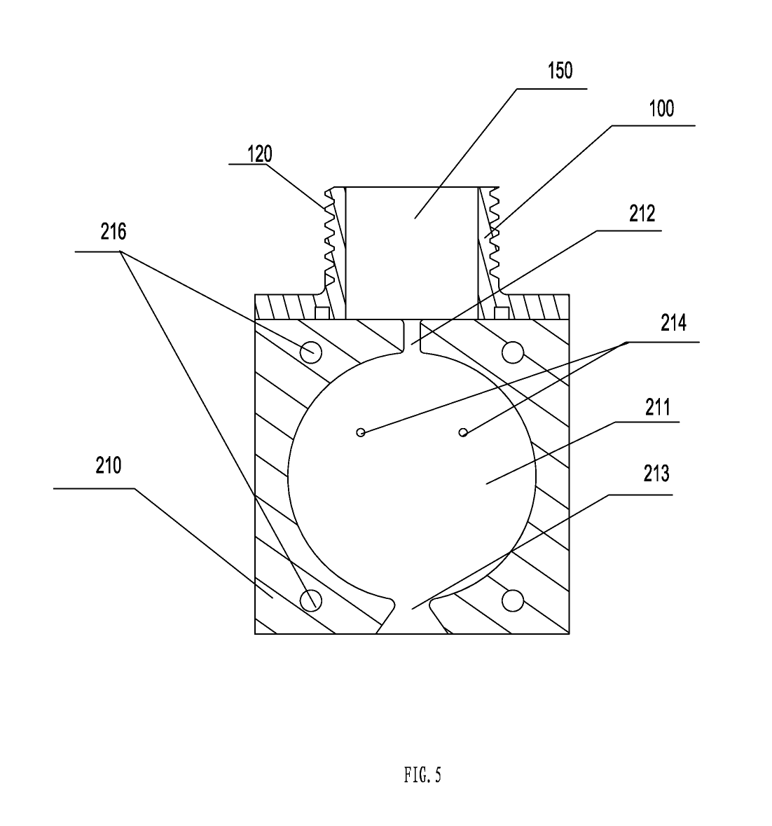

FIG. 6 illustrates the sectional view of the side view of the present invention.

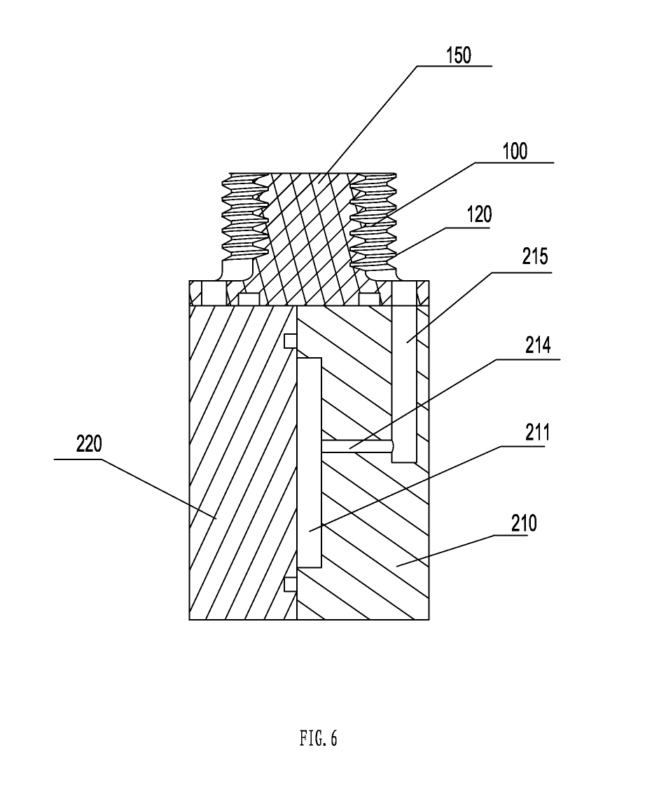

FIG. 7 illustrates the top view of the present invention.

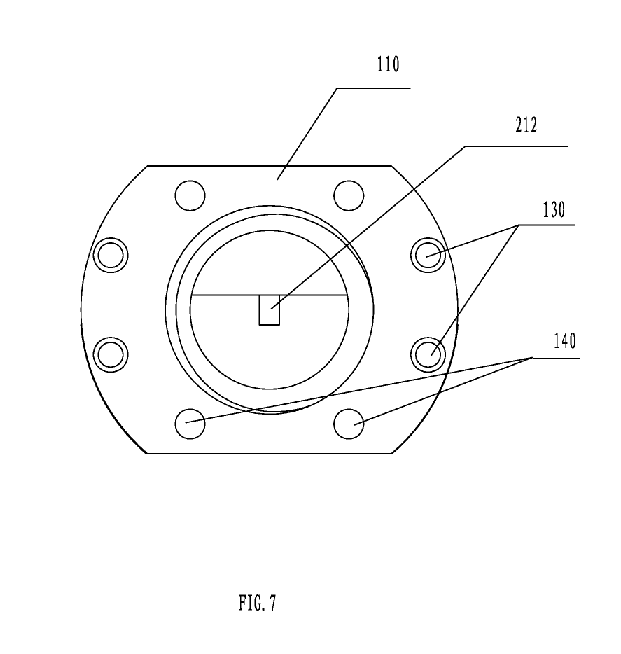

### DETAILED DESCRIPTION OF THE EMBODIMENTS

An assembly for producing forficiform spray includes a base body, which is disposed with an inlet nozzle 100 and a cavity body 200; the centre of the inlet nozzle 100 is a hollow inlet waterway 150, one end of the inlet nozzle 100 is disposed with external threaded 120, the other end is a flanged base 110. The flanged base 110 is disposed with thread holes 130 and through holes 140; the cavity body 200 is consist of a main water body 210 and a cover 220. the upper of the cavity body 200 is disposed with a thread hole corresponding to the thread hole 130 of the flanged base 110 of the inlet nozzle 100 in position and size; the inlet nozzle 100 is fixed to the cavity body 200 by bolts threaded to the thread holes 130.

Thereinto, the centre of the main water body 210 is disposed with a circular groove 211, the bottom of which is in a same horizontal plane.

The centre of the upper end and lower end of the main water body 210 are disposed with an inlet 211 and an outlet 213 connected to the circular groove 211; the inlet 212 and the outlet 213 are separately disposed in the upper end and the lower end of the circular groove 211 in the radial direction; the upper of the outlet 213 is larger than the inlet 212, the upper of the outlet 213 is big end down with forktail shape, the inlet 212 and the outlet 213 are chamfered arc; the inlet 212, the circular groove 211 and the outlet 213 form a waterway.

The bottom of the circular groove 211 of the main water body 210 is disposed with two air holes 214, which are symmetrically disposed in two sides of the centre of the lines of the inlet 212 and outlet 213, two air holes 214 are situated at the bottom of the circular groove 211 near the inlet 212.

In the end of the main water body 210 near the inlet 212 is disposed with an airway 215 corresponding to the air hole 214 in quantity and position, the airway 215 is connected to the air hole 214.

In the flanged base 110 of the inlet nozzle 100 is disposed with through holes 140 in the position corresponding to the airway 215.

Four corners of the main water body 210 and the cover 220 are separately disposed with thread hole 216 and thread hole 221, the main water body 210 is fixed to the cover 220 by bolt threaded to the thread hole 216 and 221.

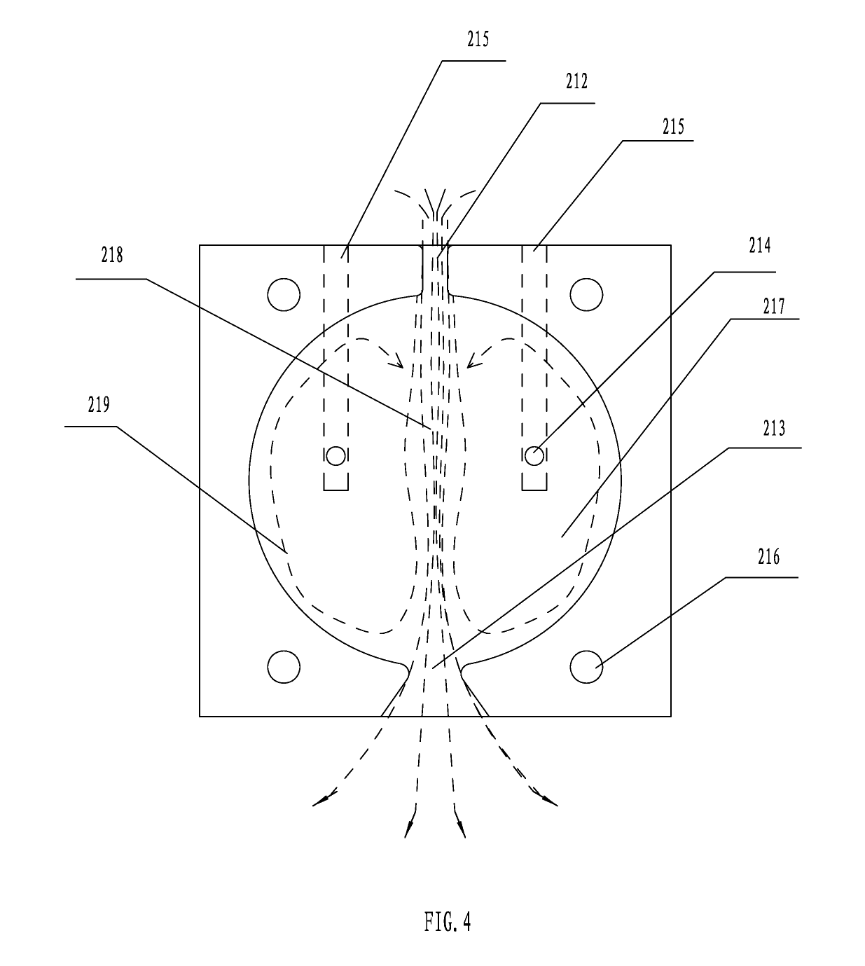

The water trend of the present invention during usage is described with the FIG. 4.

As figured in FIG. 4, when the present invention is used, main water flows to the circular groove 211 from the inlet 212, as the diameter of the inlet 212 is small, the motion energy of the water is increased and the speed of the water is relatively large.

The end of the inlet 212 is chamfered arc, water is stagnated here than dispersed when it is running into the circular groove 211, as the diameter of the outlet 213 is slightly larger than that of the inlet 212, one part of the water runs out of the outlet 213, the other part impacts two circular-like inner walls of the circular groove to form a feedback water 219; the feedback water 219 and the main water 218 from the inlet 212 form a closed water cavity 217, based on Bernoulli principle, the closed water cavity 217 is gradually contracted to make the two air holes 214 at the bottom of the circular groove 211 worked with strong suction, making the air entering into the circular groove 211 from the airway 215 and the air hole 214. Right now the air is mixed with the main water, making the specific volume of the mixture doubled and increased; when the mixture is running out of the outlet 213 in high speed, one part is adhesion to the two sides of the forktail-like outlet 213, increasing the spraying area.

As the speed of the water in the outlet 213 is increased, the other time the volume of the inlet 212 is less than that of the outlet 213, water in two sides of the outlet 213 is dropping down, one part of the water is directly running out of the outlet 213, reducing the spraying area; the other part of the water impacts the walls of the circular groove 211 again to form feedback water, the feedback water and the main water from the inlet 212 form closed water cavity 217 again, the closed water cavity 217 is contracted again, making the air hole 214 worked with suction again, again the water is sprayed with large area from the forktail-like outlet 213. the water spraying area is periodically reduced or increased, similar to a working forficiform, the outlet water is forficiform water.

### INDUSTRIAL APPLICABILITY

The present invention is provided with an assembly for producing forficiform spray, the periodod the forficiform spray is stable, the water is full in granule, the suction effect is obvious, and it has well visual effect. When the present invention is assembled in a massage nozzle, the forficiform spray is good for the body with well massage effect. And the assembly is simple in structure and low in cost. It is assembled by bolt, making it easy to clean.

What is claimed is:

1. An assembly for producing forficiform spray, comprising a base body, the base body is disposed with a waterway inside; wherein the waterway includes an inlet, an outlet and a circular cavity, the circular cavity is connected between the inlet and the outlet; the diameter of the outlet is larger than that of the inlet, the outlet is conical shaped with big end down; the base body is disposed with an air hole throughout of the circular cavity inside and outside.

2. An assembly for producing forficiform spray according to claim 1, wherein the joint of the inlet and the circular cavity is chamfered arc.

3. An assembly for producing forficiform spray according to claim 1, wherein the base body includes a cavity body, which includes a main water body and a cover, the main water body is disposed with the inlet, the outlet and a circular groove connected between the inlet and the outlet, the main water body is fixed to the cover; the circular groove is formed the circular cavity.

4. An assembly for producing forficiform spray according to claim 3, wherein the base body further includes an inlet nozzle, the centre of which is a hollow inlet waterway, one end of the inlet nozzle is disposed with external threaded, the other end is a flanged base, the flanged base is disposed with thread holes, the upper end of the cavity body is disposed with thread holes corresponding to the thread holes of the flanged base of the inlet nozzle in position and size.

5. An assembly for producing forficiform spray according to claim 4, wherein the bottom of the circular groove is in a same horizontal plane, the inlet and the outlet are separately disposed with the upper and the lower end of the circular groove in the radial direction; the outlet is forked tail shaped of big end down.

6. An assembly for producing forficiform spray according to claim 5, wherein the air hole is disposed at the bottom of the circular groove in the position near the inlet.

7. An assembly for producing forficiform spray according to claim 5, wherein the bottom of the circular groove of the main water body is disposed with two air holes.

8. An assembly for producing forficiform spray according to claim 7, wherein two air holes are symmetrically disposed in two sides of the line of the centers of the inlet and the outlet.

9. An assembly for producing forficiform spray according to claim 5, wherein the end of the main water body and the cover near the inlet is disposed with an airway corresponding to the air hole in quantity and position, the airway is connected to the air hole.

10. An assembly for producing forficiform spray according to claim 9, wherein a through hole is disposed in the flanged base of the inlet nozzle in the position corresponding to the airway.

11. An assembly for producing forficiform spray according to claim 10, wherein the water from the inlet is stagnated in the joint of the inlet and the circular groove, and then the water is dispersed when it is running into the circular groove, one part of the water runs out of the outlet, the other part impacts two circular-like inner walls of the circular groove to form a feedback water; the feedback water and the main water from the inlet form a closed water cavity; the closed water cavity is gradually contracted to make the two air holes at the bottom of the circular groove worked with strong suction, making the air entering into the circular groove from the airway and the air hole; the air is mixed with the main water, making the specific volume of the mixture doubled and increased; when the mixture is running out of the outlet in high speed, one part is adhesion to the two sides of the forktail-like outlet, increasing the spraying area; the other time the volume of the inlet is less than that of the outlet, water in two sides of the outlet is dropping down, one part of the water is directly running out of the outlet, reducing the spraying area; the other part of the water impacts the walls of the circular groove again to form feedback water, the feedback water and the main water from the inlet form closed water cavity again, the closed water cavity is contracted again, making the air hole worked with suction again, again the water is sprayed with large area from the forktail-like outlet, the water is forficiform water.

12. An assembly for producing forficiform spray according to claim 2, wherein the base body includes a cavity body, which includes a main water body and a cover, the main water body is disposed with the inlet, the outlet and a circular groove connected between the inlet and the outlet, the main water body is fixed to the cover; the circular groove is formed the circular cavity.

13. An assembly for producing forficiform spray according to claim 12, wherein the base body further includes an inlet nozzle, the centre of which is a hollow inlet waterway, one end of the inlet nozzle is disposed with external threaded, the other end is a flanged base, the flanged base is disposed with thread holes, the upper end of the cavity body is disposed with thread holes corresponding to the thread holes of the flanged base of the inlet nozzle in position and size.

14. An assembly for producing forficiform spray according to claim 13, wherein the bottom of the circular groove is in a same horizontal plane, the inlet and the outlet are separately disposed with the upper and the lower end of the circular groove in the radial direction; the outlet is forked tail shaped of big end down.

15. An assembly for producing forficiform spray according to claim 14, wherein the air hole is disposed at the bottom of the circular groove in the position near the inlet.

16. An assembly for producing forficiform spray according to claim 14, wherein the bottom of the circular groove of the main water body is disposed with two air holes.

17. An assembly for producing forficiform spray according to claim 16, wherein two air holes are symmetrically disposed in two sides of the line of the centers of the inlet and the outlet.

18. An assembly for producing forficiform spray according to claim 14, wherein the end of the main water body and the cover near the inlet is disposed with an airway corresponding to the air hole in quantity and position, the airway is connected to the air hole.

19. An assembly for producing forficiform spray according to claim 18, wherein a through hole is disposed in the flanged base of the inlet nozzle in the position corresponding to the airway.

20. An assembly for producing forficiform spray according to claim 19, wherein the water from the inlet is stagnated in the joint of the inlet and the circular groove, and then the water is dispersed when it is running into the circular groove, one part of the water runs out of the outlet, the other part impacts two circular-like inner walls of the circular groove to form a feedback water; the feedback water and the main water from the inlet form a closed water cavity; the closed water cavity is gradually contracted to make the two air holes at the bottom of the circular groove worked with strong suction, making the air entering into the circular groove from the airway and the air hole; the air is mixed with the main water, making the specific volume of the mixture doubled and increased; when the mixture is running out of the outlet in high speed, one part is adhesion to the two sides of the forktail-like outlet, increasing the spraying area; the other time the volume of the inlet is less than that of the outlet, water in two sides of the outlet is dropping down, one part of the water is directly running out of the outlet, reducing the spraying area; the other part of the water impacts the walls of the circular groove again to form feedback water, the feedback water and the main water from the inlet form closed water cavity again, the closed water cavity is contracted again, making the air hole worked with suction again, again the water is sprayed with large area from the forktail-like outlet, the water is forficiform water.
